(19) United States
(12) Patent Application Publication
(10) Pub. No.: US 2007/0101765 A1
(43) Pub. Date: May 10, 2007

(54) Process for producing flat glass, particularly flat glass convertible to float glass

(76) Inventors: Bernd Loeffelbein, Saulheim (DE); Andreas Langsdorf, Ingelheim (DE); Christian Kunert, Mainz-Kastel (DE); Frank-Thomas Lentes, Bingen (DE); Ulrich Lange, Mainz (DE); Wolfgang Schmidbauer, Mainz (DE)

Correspondence Address: STRIKER, STRIKER & STENBY, 103 EAST NECK ROAD, HUNTINGTON, NY, 11743, US

(21) Appl. No.: 11/592,807

(22) Filed: Nov. 3, 2006

(30) Foreign Application Priority Data
Nov. 10, 2005 (DE) 10 2005 053 641.7

(51) Int. Cl. C03B 18/02; C03B 13/00

(52) U.S. Cl. 65/99.1

(57) ABSTRACT

In a process for the production of flat, particularly float glass that can be converted into glass ceramic, a liquid film consisting in particular of the float bath metal is formed between the wetback tile, and optionally the restrictor tiles, and the glass stream. The tiles preferably consist of a porous material through the pores of which is pressed the liquid for creating the film.

### CROSS-REFERENCE TO PRIORITY DOCUMENT

The invention described and claimed hereinbelow is also described in DE 10 2005 053 641.7-45, filed Nov. 10, 2005. This German Patent Application, whose subject matter is incorporated here by reference, provides the basis for a claim of priority of invention under 35 U.S.C. 119 (a)-(d).

### CROSS REFERENCE TO A RELATED APPLICATION

The subject matter of this application is related to co-pending U.S. patent application, Docket No. 3899 to Loeffelbein et al.

### BACKGROUND OF THE INVENTION

The process for producing float glass has been well known for decades. According to the conventional process, liquid glass is allowed to flow continuously over a spout lip onto the molten metal of the float bath. There the glass spreads out on the float bath until its equilibrium thickness is about 7 mm after which the glass ribbon is further stretched out on the float bath to a thickness of 0.5 to about 5 mm which is desired for the glass ribbon.

At the spot where the liquid glass meets the float bath, a shoulder is formed. Most of the glass flows forward in the direction of the float bath outlet, but a part of it flows backward and from there sideways. The part of the float tank in which the glass flows backward is referred to as the wetback region. The wetback region of the float glass is approximately funnel-shaped and opens in the direction of the float tank outlet. The two sides of the funnel usually consist of ceramic tiles known as the restrictor tiles. The narrow part of the funnel is formed by the front wall of the float tank or a ceramic tile disposed ahead of it, referred to as the wetback tile.

The glass flowing backward touches the wetback tile and the restrictor tiles, is deviated by them and flows with the main part of the glass in the direction of the float tank outlet.

It was discovered previously that the pool of glass appearing in the wetback region can cause defects in the glass. In the glass pool, the residence time of the glass on the float bath is longer than that of the glass that flows directly to the outlet. This can lead to a different viscosity, because the glass cools more, but devitrification and decomposition can also take place.

It is therefore already known (for example, from German patent DE 1 596 590) to heat the marginal strips of the glass ribbon in the wetback region by passing through an electric current and thus again lowering the viscosity in this region.

Another method is known from DE-A-2 218 275, according to which the flow velocity of the liquid glass can be improved by special shaping of the entire guiding element. Moreover, according to this publication it is possible to provide in the wetback region between the glass and the molded tile a gas cushion to support the glass. In this case, however, gas may end up under the glass and lead to disturbances in the glass ribbon as well as to un-desirable turbulence in the float bath.

Carrying out the indicated processes with crystallizable glass varieties usually gives rise to products that do not meet the increased requirements. In fact, in the temperature range in which for the purpose of stretching the glass ribbon it is necessary to work with relatively low cooling rates, a crystallization also takes place so that the later ceramization of the glass, namely the conversion of the glass into a glass ceramic in which the glass, for the purpose of nucleation must be kept for an exactly determined time at an exactly defined temperature, and is then, at a higher temperature, allowed to grow crystals from the nuclei formed, is negatively affected during the stretching of the glass ribbon by the undesirably formed crystals.

The wetback tile and restrictor tiles can act as heterogeneous nuclei which because of the long residence time in the wetback region can lead to disturbing crystal formation at the edge. During the later ceramization, this, in turn, leads to irregularities, particularly to marked strains in the glass ribbon which can cause the glass to break in the annealing oven.

This problem has thus far been attacked in two ways. On the one hand, glass varieties have been developed which are less susceptible to form such trouble spots and, on the other, the unwanted crystallization or nucleation is counteracted by a purposeful formation of a stream in the bath metal.

According to U.S. Pat. No. 3,684,475, by means of a recycle pump, a laminar flow of the bath metal is created which equals in speed the glass ribbon on the metal bath as a result of which an uneven speed of the bath metal in the edge region and an uneven crystallization associated therewith, particularly in the edge region, are prevented. According to WO 2005/0 731 38 A1, too, a stream of bath metal is introduced into the wetback region which is intended to prevent the backward spreading of the “onion” so far that the glass can no longer form a fixed point on the wetback tile. In the absence of a fixed point, however, it is difficult to hold the position of the glass ribbon stable so that a defined shaping of the glass ribbon is made difficult. Moreover, in this manner impurities stemming from the spout lip are also prevented by the flow from reaching the edge region and thus cannot end up in the product.

A similar process is known from EP 0 850 888 A1. In this case, in the float bath, in the region of the edges of the glass ribbon a vertical stream is created whereby the position of the edge of the glass ribbon on the float bath can be controlled.

GB 1,158,958 A describes a process whereby the restrictor tiles consist of a gas-permeable material from which compressed air is blown against the glass to reduce the friction at the restrictor tiles. A particular drawback of this process is that the gas can end up under the glass surface which prevents the formation of a high-quality glass ribbon.

### SUMMARY OF THE INVENTION

The object of the invention is to provide a float process which is easy to carry out and which even in the floating of glasses prone to crystallization (for example green glasses for the production of glass ceramic plates) prevents the undesirable devitrifications in the edge regions to an extent such that neither increased strains appear in the glass ribbon nor is the glass broken in the annealing oven. In this process, particularly to ensure the shaping of the glass ribbon, the proven wetback and restrictor tiles in the wetback region can find continued use in the wetback region so as to ensure the constant position of the glass ribbon in the wetback region.

Surprisingly, by forming a liquid film of float bath metal on the boundary walls in the wetback region that come in contact with the liquid glass, the velocity at which the glass is guided along the boundary walls can be increased to an extent such that the formation of crystal- nuclei or of crystals during the subsequent phases of the float process does not occur at all or is so slight that it no longer causes any disturbing effects. Moreover, the liquid film prevents a direct contact with the wetback tiles and restrictor tiles so that they cannot initiate crystallization.

DE 1 212 690 describes a float process for the production of thick glass, namely glass that exceeds the approximately 7-mm equilibrium thickness. By this process, the natural spreading of the glass is prevented in that the glass is dammed up at the lateral walls of the float tank. To reduce the friction between the glass and the lateral walls, a lubricating film of molten oxide or metal is created between the wall and the glass. Excess metal overflows the edge of the tank into a collecting duct. This, however, is possible only because the thickness of the glass exceeds the equilibrium thickness. This process is not suitable for the production of flat glass having a thickness below the equilibrium thickness, because firstly the glass does not come in contact with the lateral walls of the float glass tank and secondly an overflow of the metal over the edge of the tank would not be possible because of the insufficient thickness.

Depending on the condition under which the float process is carried out, in the wetback region the glass comes in contact only with the front wall or with a shaped element disposed ahead of the front wall. Much more frequent, however, are processes in which in addition to the wetback tile two shaped elements (restrictor tiles) extending in the flow direction of the melt are present which guide the glass melt in the wetback region and, as seen in the direction of glass flow, a slight distance beyond it. All boundary surfaces coming in contact with the liquid glass must be provided with and heated by the liquid film so that crystal formation (nucleation) cannot occur on them. By boundary surfaces are meant all surfaces, shaped elements and the like that come in contact with the melt. The surfaces need not consist of ceramic, but may be fabricated from a suitable metal, or shaped ceramic elements with a metal cladding may be used. As a rule, however, be-cause of cost-related reasons, shaped elements made of fire-resistant ceramic material are used.

The liquid film between the glass and the boundary surface is most advantageously formed by using a porous material for the element forming the boundary surface or at least a material at which the surface facing the glass is provided with a material through the pores of which the liquid or the liquid metal is fed for the purpose of creating the liquid film.

The liquid is supplied from the backside. Because the liquid consists of the metal of the float bath and thus has a high specific gravity and a relatively high viscosity, the porosity and pore size are not so critical.

A porous material with a porosity from 30 to 70 percent and a pore size from 0.02 to 1.0 mm preferably is used. It is, of course, also possible to use instead of the porous material a material provided with numerous bores or slits through which the film-forming liquid metal can be supplied to the surface.

The pressure under which the liquid can be supplied is relatively low and, of course de-pending on the pore size and thickness or pressure drop within the material to be permeated, amounts to 0.05 to 1.0 bar.

It is possible to use as the porous material any material that is inert toward the liquid, the surrounding atmosphere and at the prevailing temperature. Preferred are porous ceramics, for example Al₂O₃, ZrO₂ and aluminosilicates, but porous metals, for example sintered tungsten metal, porous graphite and similar materials are also well suited.

Because the film-forming liquid consists of the bath metal of the float bath, the outflowing liquid film can readily be recycled to the float bath and it is also possible to remove from the float bath the liquid needed to create the liquid film. Advantageously, the liquid is filtered to remove solid particles. The circulation of the bath liquid from the bath through the purification system to the porous material can be accomplished with the usual pumps, for example with electromagnetic liquid metal pumps such as those used for circulating the float bath metal.

As a rule, the temperature of the film-forming liquid should be equal to the temperature of the float bath in the wetback region, namely it should be in the range from about 1000° C. to 1300° C. It can also be advantageous, however, if the temperature at which the film-forming liquid is pressed through the porous material exceeds the temperature of the float bath in the wetback region by as much as 150° C. In this manner, the glass layer coming in contact with the film-forming liquid can be kept hot longer which counteracts crystal formation (nucleation) in an especially effective manner.

### BRIEF DESCRIPTION OF THE DRAWINGS

The invention will be explained in greater detail by way of the drawings in which:

FIG. 1 shows a longitudinal section through the wetback region of a float unit according to the invention; and

FIG. 2 shows a top view of the wetback region of a float tank with wetback and restrictor tiles.

### DETAILED DESCRIPTION OF THE PREFERRED EMBODIMENTS

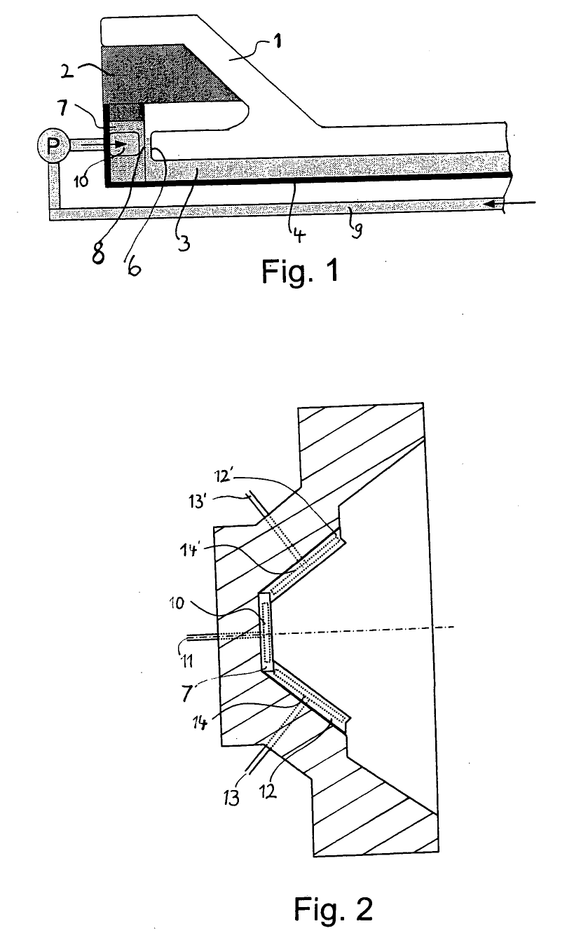

FIG. 1 shows a schematic view of the inlet zone (wetback region) of a float glass unit. The liquid glass 1 flows over a spout lip 2 onto the metal bath 3 which is kept in a tank 4. As can be seen, the glass flowing onto the bath forms a heel 6 which butts up against a wall 8 formed by a ceramic tile 7 (wetback tile). Wall 8 is porous and through it pump P presses the liquid bath metal 9 which between wall 8 and heel 6 forms a film that prevents the glass of heel 6 from coming in direct contact with the ceramic tile 7 (wetback tile). In ceramic tile 7 is disposed a distribution channel 10 which ensures an even distribution of the molten metal within the ceramic tile.

FIG. 2 shows a top view of the wetback region from which for better comprehension the spot lip has been omitted. The drawing shows the wetback tile 7 with the supply line 11 for the liquid bath metal and with the distribution channel 10, indicated by dashed lines, disposed within the wetback tile. Wetback tile 7 adjoins on both sides restrictor tiles 12 and 12′ which are disposed in funnel fashion, with the funnel opening in the direction of the glass flow. The restrictor tiles still come in contact with the molten glass and are also supplied with liquid metal by way of supply lines 13, 13′ and distribution channels 14, 14′.

It will be understood that each of the elements described above, or two or more together, may also find a useful application in other types of constructions differing from the types described above.

While the invention has been illustrated and described as embodied as a process for producing flat glass, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A process for producing readily crystallizing flat glass, comprising the steps:
in a float glass unit, pouring liquid glass in the form of a glass stream onto a metal in a pouring zone where the liquid glass is shaped to form a ribbon of a desired width and thickness, whereby the glass stream in the pouring zone impinges on a wetback tile and/or restrictor tiles, wherein in the pouring zone, between the wetback tile and/or the restrictor tiles and the glass stream, a film of float bath metal is formed, wherein the film of float bath metal prevents direct contact between the liquid glass and the wet-back tile and/or the restrictor tiles.

2. The process as defined in claim 1, wherein the liquid glass being poured is a precursor glass for a glass ceramic.

3. The process as defined in claim 1, wherein at least one ceramic tile is used as a boundary wall, said at least one ceramic tile consisting of a porous material, wherein liquid for creating the liquid film is pressed through pores of the material.

4. The process as defined in claim 3, wherein the metal of the float bath is used as the liquid for creating the liquid film.

5. The process as defined in claim 3, wherein three boundary walls are used.

6. The process as defined in claim 3, wherein a distribution channel for the liquid is provided in the boundary wall.

7. The process as defined in one of claims 3, wherein the liquid used is at a temperature between the temperature of the bath metal in the pouring zone and a temperature that is as much as 150° C. higher.

8. The process as defined in claim 3, wherein a side of the at least one ceramic tile facing the glass is provided with a layer of a porous material.

9. Flat glass, particularly precursor glass for a glass ceramic, produced in accordance with claim 1.
